(19) United States
(12) Patent Application Publication
(10) Pub. No.: US 2009/0048942 A1
(43) Pub. Date: Feb. 19, 2009

(54) Electronic business method for the wholesale transaction of vehicles

(75) Inventors: John G. Bouwens, West Olive, MI (US); Randy A. Katt, Holland, MI (US); Todd Cinnamon, Holland, MI (US)

Correspondence Address: King & Partners, PLC, 170 College Avenue, SUITE 230, HOLLAND, MI, 49423, US

(73) Assignee: SkipAuction, LLC.

(21) Appl. No.: 11/891,900

(22) Filed: Aug. 14, 2007

(51) Int. Cl. G06Q 30/00; G06F 17/30; G06F 17/40

(52) U.S. Cl. 705/27

(57) ABSTRACT

An electronic business method for the wholesale transaction of a vehicle having the steps of: providing an electronic information database, wherein the electronic information database comprises a wholesale vehicle record and/or a dealership record; authenticating a dealership from a dealership information entry of a dealership record to verify authenticity of the dealership; providing an authenticated dealership with access to the electronic information database; permitting the authenticated dealership to input a search inquiry to generate a search of the electronic information database; generating a search result which provides the authenticated dealership with a wholesale vehicle information record and/or a dealership information record; and facilitating a wholesale vehicle transaction between the authenticated dealership and another authenticated dealership from the search result.

### CROSS-REFERENCE TO RELATED APPLICATION(S)

Not Applicable

### BACKGROUND OF THE INVENTION

1. Field of the Invention

The present invention relates in general to a business method and, more particularly, to an electronic business method for the wholesale transaction of vehicles generally between authorized, wholesale vehicle dealers which reduces and/or eliminates the need for conventional vehicle auctions and costs associated therewith.

2. Background Art

Automobile auctions, as they stand today, are a time and resource intensive undertaking. Generally a vehicle dealership is required to register with a state and/or purchase costly memberships to participate in local, regional and/or national vehicle auctions. Dealers are also required to physically deliver any vehicles that they wish to sell at an auction to an auction house, which involves expensive transportation and valuable time that is wasted on the logistics of getting vehicles to an auction house in a timely manner.

A dealership also loses a portion of the sale price of the vehicle to an auction house as an administrative cost. To help the reader appreciate the numerous fees associated with an auction we have included a quotation from Ralph Liniado, Vice President of Development for Cox Enterprises, which owns Manheim Online Auctions, namely: “We get a fee for putting them through the auction and for certain administrative functions; we get a fee for actually selling the car; and we get a fee for reconditioning the car at various levels. That's where our revenue streams come from.” Communications of AIS Volume 1, Page 3, Manheim Auctions by P. G. McKeown and R. T. Watson.

Dealerships in certain states may have to transport their vehicles a great distance to place them with the best possible auction house so that the dealership's profit can be maximized. With the ever-increasing cost of fuel and transportation this single factor alone may keep certain authorized wholesale dealerships from participating in the transaction of wholesale vehicles.

Applicant respectfully submits that commerce between authorized wholesale dealerships should no longer be bound by unreasonable logistical restraints including physical proximity to auction houses that only stifle a dealership's ability to grow and succeed. Allowing dealers to maximize profits from the sales and acquisitions of wholesale vehicles is not only a benefit to the dealership, but can also extend further down into the marketplace. By retaining more profits from wholesale transactions, authorized wholesale dealerships can offer more competitive prices to consumers.

Accordingly, it is an object of the present invention to remedy the aforementioned drawbacks associated with conventional vehicle auction transactions. Indeed, an electronic business method for the transaction of wholesale vehicles among authorized wholesale dealerships, as disclosed herein, enables dealerships to omit the costly aforementioned processes that greatly diminish profit margins on wholesale vehicles. Moreover, the present invention will likely enhance the overall profitability of a dealership, thereby leveling the “playing field” in the wholesale vehicle market.

These and other objects of the present invention will become apparent in light of the present specification, claims, and drawings.

### SUMMARY OF THE INVENTION

In one embodiment, the present invention is directed to an electronic business method for the wholesale transaction of a vehicle, comprising the steps of: (a) providing an electronic information database, wherein the electronic information database comprises: (1) a wholesale vehicle record, wherein the wholesale vehicle record comprises one or more wholesale vehicle information entries, and/or (2) a dealership record, wherein the dealership record comprises one or more dealership information entries; (b) authenticating a dealership from one or more dealership information entries of a dealership record to verify authenticity of the dealership; (c) providing an authenticated dealership with access to at least a portion of the electronic information database; (d) permitting the authenticated dealership to input a search inquiry to generate a search of the electronic information database; (e) generating a search result which provides the authenticated dealership with a wholesale vehicle information record and/or a dealership information record from the electronic information database; and (f) facilitating a wholesale vehicle transaction between the authenticated dealership and another authenticated dealership from the search result.

In a preferred embodiment of the present invention, the electronic business method further comprises the step of permitting an authenticated dealership to input one or more dealership information entries into a dealership record in the electronic information database.

In another preferred embodiment of the present invention, the electronic business method further comprises the step of storing one or more dealership records in the electronic information database.

In yet another preferred embodiment of the present invention, the electronic business method further comprises the step of permitting an authenticated dealership to input one or more wholesale vehicle information entries into a wholesale vehicle record in the electronic information database.

In another aspect of the present invention, the electronic business method further comprises the step of storing one or more wholesale vehicle records in the electronic information database.

In a preferred embodiment of the present invention, the wholesale vehicle information entry is selected from one or more of the group comprising vehicle identification number, vehicle make, vehicle model, vehicle year, vehicle mileage, vehicle condition, vehicle equipment, vehicle trim level, vehicle option package, vehicle options, vehicle financing program, vehicle sales program, vehicle owner information, and/or combinations thereof.

In another preferred embodiment of the present invention, the vehicle equipment is selected from one or more of the group comprising keys and ignition, remote entry system, power windows, power locks, power mirrors, trunk release mechanism, fuel lid release mechanism, power seats, headlights, turn signals, windshield wiper controls, emergency flashers, odometer, trip meter, speedometer, tachometer, cruise control, emergency brake, radio, compact disk player, cassette player, air conditioning, heating and climate control systems, clock, multiple information display, warning lights, electro-chromic mirror, power outlets, external communication systems, cup holders, storage compartments, tires, seat belts, air bags, safety restraints, sun shades, and/or combinations thereof.

In another aspect of the present invention, the dealership information entry is preferably selected from one or more of the group comprising dealership name, dealership address, dealership registration number, dealership phone number, dealership contact, cross-reference with associated dealerships, and/or combinations thereof.

In yet another preferred embodiment of the present invention, the step of providing the electronic information database comprises the step of providing a computer having the electronic information database stored thereon.

In accordance with the present invention, the step of providing an authenticated dealership with access to at least a portion of the electronic information database preferably occurs after the step of authenticating a dealership.

In one embodiment of the present invention, the dealership record comprises a dealership name entry, a dealership registration number entry, and/or a dealership location entry.

In a preferred embodiment of the present invention, the step of authenticating further comprises contacting the Secretary of State and/or a state licensing agency in the State in which the dealership is incorporated to validate the authenticity of the dealership and the dealership location. In this embodiment the dealership location entry preferably comprises a zip code, postal code, country code, telephone area code, address, and/or combinations thereof.

In another preferred embodiment of the present invention, the electronic business method further comprises the step of searching the electronic information database for a wholesale vehicle record and/or a dealership record within the authenticated dealership's location.

In yet another preferred embodiment of the present invention, the electronic business method further comprises the step of searching the electronic information database for a wholesale vehicle record and/or a dealership record within a predetermined distance from the authenticated dealership and/or a predetermined location.

In one embodiment of the present invention, the step of generating a search result comprises the step of comparing the search inquiry to the wholesale vehicle record and/or the dealership information record in the electronic information database.

In another preferred aspect of the present invention, the electronic business method further comprises the step of verifying the availability of a vehicle generated from the search result.

The present invention is also directed to an electronic business method for the wholesale transaction of a vehicle, wherein the method further comprises the step of permitting the authenticated dealership to reserve, and/or purchase a wholesale vehicle at a location of either the authenticated dealership or another authenticated dealerships' designated location.

### BRIEF DESCRIPTION OF THE DRAWINGS

The invention will now be described with reference to the drawings wherein:

FIG. 1 is a flowchart representing the electronic information database structure showing, among other things, how constituent information such as vehicle features, wholesale vehicle index information, and dealer information flows into the wholesale vehicle record and the dealer record, and how those in turn flow into the electronic information database; and

FIG. 2 is a flowchart describing the electronic business method showing, among other things, the process by which a dealership gains access to the electronic information database, what information is necessary for access to the electronic information database, the method of authentication, the method of search the electronic information database, returning a search request, and the steps of either reserving, purchasing or reserving and purchasing a wholesale vehicle. It also shows a method by which dealerships can search for other dealerships and contact one another directly to purchase wholesale vehicles.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, and/or methods referred to herein, may be identified throughout the drawings with like reference characters.

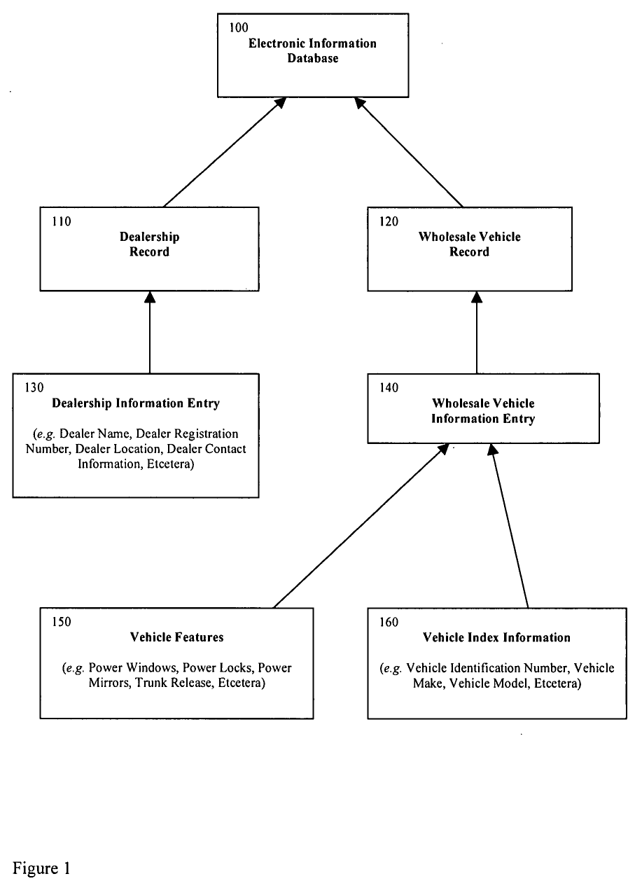

Referring now to the drawings and to FIG. 1 in particular, a flowchart is provided which identifies, in one embodiment, the data structure of electronic information database 100. Electronic information database 100 preferably comprises two main sub data structures, namely: wholesale vehicle record 120 and dealer record 110. Wholesale vehicle record 120 comprises two general types of information, namely: vehicle features 150 and wholesale vehicle index information 160. Dealer information record 110 comprises dealer information 130 which, in turn, comprises entries such as dealership name, dealership address, dealership registration number, contact phone number—just to name a few.

Vehicle features 150 comprises data relating to the particular features of each vehicle. Some examples of these features include: keys and ignition, remote entry system, power windows, power locks, power mirrors, trunk release mechanism, fuel lid release mechanism, power seats, headlights, turn signals, windshield wiper controls, emergency flashers, odometer, trip meter, speedometer, tachometer, cruise control, emergency brake, radio, compact disk player, cassette player, air conditioning, heating and climate control systems, clock, multiple information display, warning lights, electro-chromic mirror, power outlets, external communication systems, cup holders, storage compartments, tires, seat belts, air bags, safety restraints, sun shades, and combinations thereof.

Wholesale vehicle index information 160 comprises data related to the identification and distinguishing of wholesale vehicles that may have exactly the same vehicle features. Examples of wholesale vehicle index information 160 include vehicle identification number, vehicle make, vehicle model, vehicle year, vehicle mileage, vehicle condition, vehicle equipment, vehicle trim level, vehicle option package, vehicle options, vehicle financing program, vehicle sales program, vehicle owner information, and combinations thereof.

Both the wholesale vehicle record 120 and dealership record 110 reside in the electronic information database. It will be understood that the term “database” includes, for example, a computer, a web server, a hard drive, etcetera. It will be further understood that both wholesale vehicle record 120 and dealership record 110 may be stored in the form of a web page, a rich text format file, even a simple database file, or any other equivalent structure.

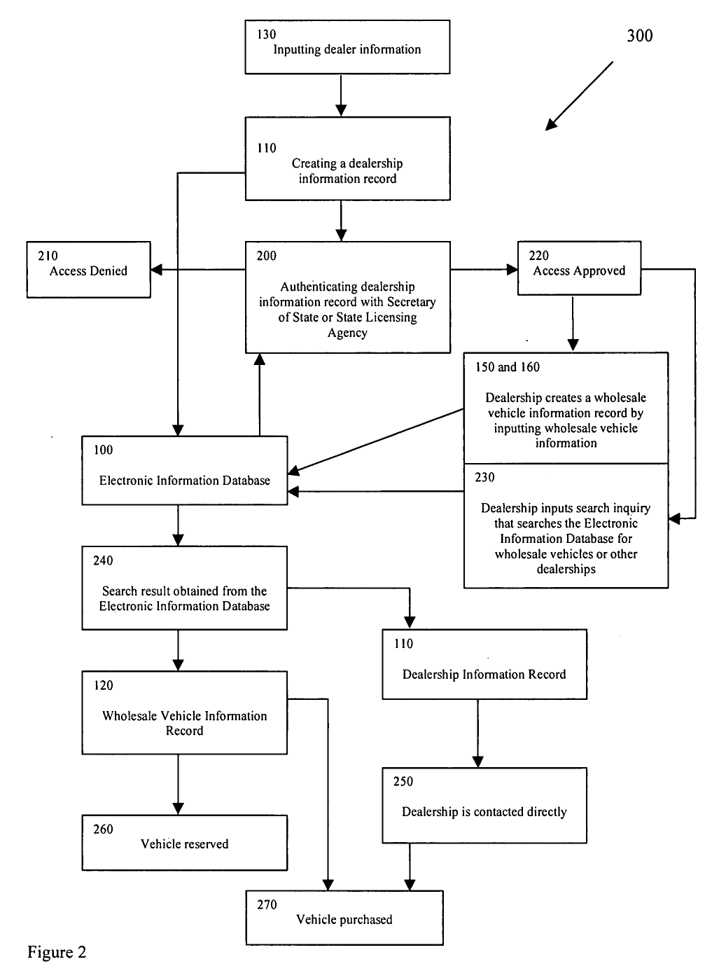

Referring now to FIG. 2, a flowchart is provided which identifies multiple embodiments of the electronic business method for the transaction (e.g. sale and/or acquisition) of wholesale vehicles between authorized wholesale dealers. Electronic business method 300 begins when a wholesale vehicle dealership creates a dealership record 110 by inputting one or more dealer information entries 130 directly and/or indirectly into electronic information database 100. Dealership information entries 130 may include, for example, any of the following: dealership name, dealership registration number, dealership location, dealership contact information, and any other pertinent information regarding the dealership. Preferably the dealership generates a dealership record by inputting its dealership name, dealership location, and dealership registration number into the electronic information database. The above-identified entries will allow an authentication entity to contact the Secretary of State and/or a State licensing agency of the State in which the dealership does business in to verify the authenticity 200 of the dealership.

After the dealership has input dealership information 130 into dealership record 110, it will be authenticated 200 to ensure that the dealership is, in fact, an authorized wholesale dealership.

The step of authenticating a dealership is preferably performed by an administrator who will take dealership information 130 from dealership record 110 and contact the Secretary of State or State licensing agency in the State where the dealership is located in order to verify the authenticity of the dealership. If dealership information 130 is verified, then access to electronic information database 100 is approved 220. If dealership information 130 is not verifiable, then access to electronic information database 100 is denied.

After verifying the authenticity of the dealership 200, then access is provided to the electronic information database 100. This step can be facilitated in any one of a number of ways, for example, by issuing the dealership a unique user identification name and a password—however any equivalent method for providing access may be used.

After the dealership has been provided access to electronic information database 100, the dealership has several options that it may exercise concurrently or separately. The first of these options is to create a wholesale vehicle record 120 by inputting wholesale vehicle information 140 which further comprises vehicle features 150 and/or wholesale vehicle index information 160. This allows the dealership to list wholesale vehicles in electronic information database 100 so that other dealerships can search 230 electronic information database 100 for wholesale vehicles. The details of what may comprise both vehicle features 150 and wholesale vehicle index information 160 are disclosed supra. It should be noted that a dealership will likely provide as much information about the wholesale vehicle in the form of vehicle features 150 and wholesale vehicle indexing information 160 so as to generate the maximum amount of search results 240 when other dealerships are searching 230 electronic information database 100.

Dealerships may also choose to perform a search of electronic information database 100 by inputting search inquiry 230 that will search electronic information database 100 for any wholesale vehicles that substantially correspond to search inquiry input 230 and a search result will be generated 240 corresponding to search inquiry 230. Such a step can be carried out by any process or processes which allow for the querying of a database and the returning of search result 240.

Search result 240, which is obtained from search inquiry 230 of electronic information database 100, will preferably be in the form of wholesale vehicle record 120 and/or dealership record 110, depending on the search inquiry that was input by the dealership.

If search result 240, obtained from search inquiry 230 of electronic information database 100 is a wholesale vehicle information record, then the dealership may pursue other options, such as reserving the wholesale vehicle 260 or purchasing the wholesale vehicle 270, or both reserving 260 and purchasing 270 the wholesale vehicle. If search result 240 is obtained from search inquiry 230 of electronic information database 100 of a dealer record, then the dealership has the option to contact the other dealership directly 250 to facilitate the negotiation and/or purchase 270 of a wholesale vehicle.

It will be understood that if a search result 240 is not satisfactorily obtained, future notification to the authorized wholesale dealer can be facilitated via email or other communication means as soon as the electronic information database comprises such a record.

The foregoing descriptions merely explain and illustrate the invention and the invention is not limited thereto except insofar as the appended claims are so limited, as those skilled in the art who have the disclosure before them will be able to make modifications without departing from the scope of the invention.

What is claimed is:

1. An electronic business method for the wholesale transaction of a vehicle, comprising the steps of:
providing an electronic information database, wherein said electronic information database comprises at least one of:
a wholesale vehicle record, wherein said wholesale vehicle record comprises at least one wholesale vehicle information entry, and
a dealership record, wherein said dealership record comprises at least one dealership information entry;
authenticating a dealership from at least one dealership information entry of a dealership record to verify authenticity of said dealership;
providing an authenticated dealership with access to at least a portion of said electronic information database;
permitting said authenticated dealership to input a search inquiry to generate a search of said electronic information database;
generating a search result which provides said authenticated dealership with at least one of a wholesale vehicle information record and a dealership information record from said electronic information database; and
facilitating a wholesale vehicle transaction between said authenticated dealership and another authenticated dealership from said search result.

2. The electronic business method according to claim 1, further comprising the step of permitting an authenticated dealership to input at least one dealership information entry into a dealership record in said electronic information database.

3. The electronic business method according to claim 2, further comprising the step of storing at least one dealership record in said electronic information database.

4. The electronic business method according to claim 1, further comprising the step of permitting an authenticated dealership to input at least one wholesale vehicle information entry into a wholesale vehicle record in said electronic information database.

5. The electronic business method according to claim 4, further comprising the step of storing at least one wholesale vehicle record in said electronic information database.

6. The electronic business method according to claim 1, wherein said wholesale vehicle information entry is selected from at least one of the group consisting of vehicle identification number, vehicle make, vehicle model, vehicle year, vehicle mileage, vehicle condition, vehicle equipment, vehicle trim level, vehicle option package, vehicle options, vehicle financing program, vehicle sales program, vehicle owner information, and combinations thereof.

7. The electronic business method according to claim 6, wherein said vehicle equipment is selected from at least one of the group consisting of keys and ignition, remote entry system, power windows, power locks, power mirrors, trunk release mechanism, fuel lid release mechanism, power seats, headlights, turn signals, windshield wiper controls, emergency flashers, odometer, trip meter, speedometer, tachometer, cruise control, emergency brake, radio, compact disk player, cassette player, air conditioning, heating and climate control systems, clock, multiple information display, warning lights, electro-chromic mirror, power outlets, external communication systems, cup holders, storage compartments, tires, seat belts, air bags, safety restraints, sun shades, and combinations thereof.

8. The electronic business method according to claim 1, wherein said dealership information entry is selected from at least one of the group consisting of dealership name, dealership address, dealership registration number, dealership phone number, dealership contact, cross-reference with associated dealerships, and combinations thereof.

9. The electronic business method according to claim 1, wherein the step of providing said electronic information database comprises the step of providing a computer having said electronic information database stored thereon.

10. The electronic business method according to claim 1, wherein the step of providing an authenticated dealership with access to at least a portion of said electronic information database occurs after the step of authenticating a dealership.

11. The electronic business method according to claim 1, wherein said dealership record comprises at least a dealership name entry, a dealership registration number entry, and a dealership location entry.

12. The electronic business method according to claim 11, wherein the step of authenticating further comprises contacting a Secretary of State or a State licensing agency in a State in which said dealership is incorporated to validate the authenticity of said dealership and said dealership location.

13. The electronic business method according to claim 11, wherein said dealership location entry comprises at least one of a zip code, postal code, country code, telephone area code, address, and combinations thereof.

14. The electronic business method according to claim 13, further comprising the step of searching said electronic information database for at least one of a wholesale vehicle record and a dealership record within said authenticated dealership's location.

15. The electronic business method according to claim 1, further comprising the step of searching said electronic information database for at least one of a wholesale vehicle record and a dealership record within a predetermined distance from said authenticated dealership.

16. The electronic business method according to claim 1, further comprising the step of searching said electronic information database for at least one of a wholesale vehicle record and a dealership record within a predetermined distance from a predetermined location.

17. The electronic business method according to claim 1, wherein the step of generating a search result comprises the step of comparing said search inquiry to at least one of said wholesale vehicle record and said dealership information record in said electronic information database.

18. The electronic business method according to claim 1, further comprising the step of verifying the availability of a vehicle generated from said search result.

19. The electronic business method according to claim 1, further comprising the step of permitting said authenticated dealership to at least one of reserve, purchase, and reserve and purchase a wholesale vehicle at a location of either said authenticated dealership or another authenticated dealerships' designated location.
